(19) United States
(12) Patent Application Publication
(10) Pub. No.: US 2024/0284278 A1
(43) Pub. Date: Aug. 22, 2024

(54) HANDLING OF RESIDUAL TIMING ADVANCE

(71) Applicant: Nokia Technologies Oy, Espoo (FI)

(72) Inventors: Rafhael MEDEIROS DE AMORIM, Aalborg (DK); Alessio MARCONE, Munich (DE); Jedrzej STANCZAK, Wroclaw (PL); Frank FREDERIKSEN, Aalborg (DK)

(21) Appl. No.: 18/443,261

(22) Filed: Feb. 15, 2024

(30) Foreign Application Priority Data
Feb. 17, 2023 (FI) 20235201

(51) Int. Cl. H04W 36/00; H04W 36/08

(52) U.S. Cl. CPC H04W 36/00725; H04W 36/083

(57) ABSTRACT

The invention inter alia pertains to an apparatus for communication with a non-terrestrial network, NTN, the apparatus comprising means configured for:
receiving, from the network, a handover configuration regarding a handover to be performed by the apparatus from a source cell to a target cell of the network;
receiving, from the network, assistance information for the apparatus to connect to said target cell; determining, based on the assistance information, a type of the handover or receiving, from the network, an indication of a type of the handover;
determining, based on the handover type, a threshold for a timing advance parameter;
determining, based on the threshold and a value of the timing advance parameter, whether to perform a RACH-less handover towards the target cell.

### TECHNOLOGICAL FIELD

The present disclosure is related to but not limited to communication networks as defined by the 3GPP standard, such as the 5G standard, also referred to as New Radio, NR. The disclosure in particular pertains to the handover (HO) in non-terrestrial networks (NTN). The invention specifically addresses the aspect of Timing Advance (TA) in non-terrestrial networks when performing RACH-less handovers.

### BACKGROUND

In the 3GPP Release 14, the concept of a RACH-less handover (HO) was introduced in 3GPP, i.e. a handover where the UE does not need to perform a Random Access (RA) procedure on a Random Access Channel (RACH). The RACH-less handover can be considered an enhancement to the conventional HO procedures, where the UE is expected to utilize the Random Access Channel to initiate the connection with the target cell. The RACH-less procedure is indicated by adding the field ra-Skip in the handover command message. If the field is included, the UE might skip the RACH step when connecting to the target cell.

However, one of the many functionalities of the RA procedure is enabling the estimation of the Timing Advance (TA) required by an UE to have its transmissions synchronized in UL with other UEs to maintain orthogonality of the received signals from multiple UEs at the base station side (such as the gNB or eNB in 3GPP context).

As defined for LTE, the UE shall have capability to follow the frame timing change of the connected eNode B. The uplink frame transmission takes place (N_{TA}+N_{TA offset})×Tₛ before the reception of the first detected path (in time) of the corresponding downlink frame from the reference cell. The reference point for the UE initial transmit timing control requirement shall be the downlink timing of the reference cell minus (N_{TA_Ref}+N_{TA offset})×Tₛ. The downlink timing is defined as the time when the first detected path (in time) of the corresponding downlink frame is received from the reference cell. N_{TA_Ref} for PRACH is defined as 0. (N_{TA_REF}+N_{TA offset})×Tₛ (in Tₛ units) for other channels is the difference between UE transmission timing and the Downlink timing immediately after when the last timing advance was applied. N_{TA_Ref} for other channels is not changed until next timing advance is received.

Similarly, for NR, it is defined that the UE shall have capability to follow the frame timing change of the reference cell in connected state or when transmitting PUSCH on CG resources for SDT in RRC_Inactive. The uplink frame transmission takes place (N_{TA}+N_{TA offset})×T_{c} before the reception of the first detected path (in time) of the corresponding downlink frame from the reference cell. The downlink timing is defined as the time when the first path (in time) of the corresponding downlink frame used by the UE to determine downlink timing is received from the reference cell at the UE antenna. N_{TA} for PRACH is defined as 0. N_{TA} for other channels is not changed until next timing advance is received.

Therefore, when moving from one cell to another, the UE is expected to “reset” its timing advance component to 0 and re-acquire a new timing advance component in the Random Access procedure. When the RACH is not performed, for example in the case of RACH-less HO, the UE is not supposed to change the current timing advance (until the next timing advance information is received).

For a RACH-less handover it is possible to indicate to the UE, the value to be used for the N_{TA} component after the HO, such as maintain the current value for the Main Cell Group or Secondary Cell Group, or set N_{TA}=0 in the RACH-Skip field.

In non-terrestrial networks (NTN), which were introduced as part of the 3GPP 5G NR Release 17, there is a high variability of the TA in Low-Earth orbit scenarios (LEO) and of the magnitude of the timing advance. Thus, the concept of “UE autonomous pre-compensation” of Timing Advance was introduced. The UE is expected to calculate the timing offset by estimating the round-trip time (RTT) of the physical layer. This estimation is based among other things on the UE own position (acquired via GNSS), the satellite ephemeris (current position, velocity and orbital parameters), and potentially also information associated to the feeder link between the gNB and the satellite (also known as the “common” TA description). Likewise, a frequency doppler offset pre-compensation in UL transmissions (and in DL reception by the UE) was also introduced using a similar estimation.

Using higher-layer ephemeris parameters for a serving satellite, if provided, a UE can pre-compensate the two-way transmission delay on the service link based on N_{TA,adj}^{UE} that the UE determines using the serving satellite position and its own position. To pre-compensate the two-way transmission delay between the uplink time synchronization reference point and the serving satellite, the UE determines N_{TA,adj}^{common} based on one-way propagation delay Delay_{common}(t) that the UE determines as:

$${Delay}_{c o m m o n} ( t ) = \text{} \frac{T {A}_{C o m m o n}}{2} + \text{} \frac{T {A}_{CommonDrift}}{2} \times ( t - {t}_{epoch} ) + \text{} \frac{T {A}_{CommonDriftVariant}}{2} \times {( t - {t}_{epoch} )}^{2}$$

where TA_{Common}, TA_{CommonDrift}, and TA_{CommonDriftVariant} are respectively provided by ta-Common, ta-CommonDrift, and ta-CommonDriftVariant and t_{epoch} is the epoch time of TA_{Common}, TA_{CommonDrift}, and TA_{CommonDriftVariant}. Delay_{common}(t) provides a distance at time t between the serving satellite and the uplink time synchronization reference point divided by the speed of light. The uplink time synchronization reference point is the point where DL and UL are frame aligned with an offset given by N_{TA,offset}.

The reference point for the UE initial transmit timing control requirement shall be the downlink timing of the reference cell minus (N_{TA}+N_{TA-offset}+N_{TA,ajd}^{common}+N_{TA,adj}^{UE})×T_{c}. The downlink timing is defined as the time when the first path (in time) of the corresponding downlink frame used by the UE to determine downlink timing is received from the reference cell at the UE antenna. N_{TA} for PRACH is defined as 0. (N_{TA}+N_{TA-offset}+N_{TA,adj}^{common}+N_{TA,adj}^{UE})×T_{c} (in T_{c} units) for other channels is the difference between UE transmission timing and the downlink timing immediately after when the last timing advance was applied or after the last update in N_{TA,adj}^{common} or N_{TA,adj}^{UE}. The value of N_{TA-offset} depends on the duplex mode of the cell in which the uplink transmission takes place and the frequency range (FR).

### SUMMARY OF SOME EXEMPLARY EMBODIMENTS

The consequence of the procedures in NTN described above is that most of the timing advance is pre-compensated by the UE autonomously. Therefore, the N_{TA} component is mostly used for “residual timing advance” as to account for inaccuracies on the GNSS implementation of the UE, systematic errors in modelling the feeder link delay (common TA component), and other potential sources of additional delays in the network such as multipath components.

When a RACH-less handover is possible or allowed in all of the usual handover scenarios, that is for both intra-satellite handover and inter-satellite handover as well as handovers with and without a gateway/gNB switch, it is assumed that the UE can perform RACH-less HO in NTN, as long as the satellite assistance information is provided to the UE, in order to allow the pre-compensation of the common TA component and the UE specific component.

However, it seems that the handling of network-controlled component N_{TA} (or N_{TA_ref} for LTE), used for residual timing advance corrections, needs enhancements. If the UE keeps the “current-value” for the N_{TA} component, it will carry on the residual timing advance towards the target cell, but the residual value might be completely different for different satellites (or different feeder links). On the other hand, making the residual component equal to zero, might be resetting a needed component of residual timing advance introduced by network due to network related offsets.

Moreover, the N_{TA} component might assume significantly higher values, sometimes higher than the CP used for normal transmission. So it is very important that the UE handles N_{TA} in a proper manner, in order to avoid transmissions in the target cell that will be completely out-of-sync (losing the transmitted energy, and possibly causing high interference to other user in the network due to loss of orthogonality of the received signals).

While it may be possible for handling the TA during a HO procedure that skips the RACH, for the UE to acquire a TA of the target cell before the cell switch is done, this does not only require additional signaling, the signaling may even be unnecessary in case the TA could actually be reused also for the target cell.

Thus, certain embodiments of the disclosure may have the effect of an improved HO in NTN. In particular, embodiments of the disclosure may have the effect of a more accurate TA directly after the HO to a target cell. Therein, certain embodiments of the disclosure may have the effect that no or only minimal additional signaling is necessary between the network and the UE.

According to a first exemplary aspect, there is disclosed an apparatus (also referred to as UE herein) for communication with a non-terrestrial network, NTN. The apparatus may comprise means configured for receiving, from the network, a handover configuration regarding a handover to be performed by the apparatus from a source cell to a target cell of the network. The means may further be configured for receiving, from the network, assistance information for the apparatus to connect to said target cell. The means may further be configured for determining, based on the assistance information, a type of the handover. Alternatively, the apparatus may receive, from the network, an indication of a type of the handover. The means may further be configured for determining, based on the handover type, a threshold for a timing advance parameter. The means may further be configured for determining, based on the threshold and a value of the timing advance parameter, whether to perform a RACH-less handover towards the target cell.

According to a second exemplary aspect, there is also disclosed a network entity for a non-terrestrial network. The network entity may comprise means configured for transmitting, to an apparatus, a handover configuration regarding a handover to be performed by the apparatus from a source cell to a target cell of the network. The means may further be configured for transmitting, to the apparatus, threshold information indicating one or more thresholds for a timing advance parameter, said one or more thresholds being associated with respective handover types.

According to each of the exemplary aspects, a respective method is also disclosed.

Thus, according to the first exemplary aspect, there is disclosed a method for communication with a non-terrestrial network, NTN, performed by at least one apparatus. The method may comprise receiving, from the network, a handover configuration regarding a handover to be performed from a source cell to a target cell of the network. The method may further comprise receiving, from the network, assistance information for the apparatus to connect to said target cell. The method may further comprise determining, based on the assistance information, a type of the handover. The method may comprise determining, based on the determined handover type, a threshold for a timing advance parameter. The method may comprise determining, based on the determined threshold and a value of the timing advance parameter, whether to perform a RACH-less handover towards the target cell.

According to the second exemplary aspect, there is also disclosed a method, performed by a network entity of a non-terrestrial network, NTN. The method may comprise transmitting, to an apparatus, a handover configuration regarding a handover to be performed by the apparatus from a source cell to a target cell of the network. The method may further comprise transmitting, to the apparatus, threshold information indicating one or more thresholds for a timing advance parameter, said one or more thresholds being associated with respective handover types.

Any of the disclosed devices (apparatus, network entity) may generally be a stationary device or a mobile device. The apparatus may in particular be a terminal device such as a user equipment, e.g. mobile device, such as a smartphone, a tablet, a wearable, a smartwatch, a low power device, an IoT device, an IIoT device, a vehicle, a truck, a drone, an airplane, or the like. The apparatus may in particular be capable of directly or indirectly communicating with (transmitting and receiving signals and/or data to/from) a network or a network entity, such as a base station of a communication network. The apparatus may at least be able to communicate with a non-terrestrial network or non-terrestrial network entity, for instance with a satellite. Nevertheless, the apparatus may still be able to communicate with terrestrial network entities.

Accordingly, a network entity may be understood to be a wireless communication station installed at a fixed or mobile location and may in particular be or comprise an entity of the radio access network of the communication system. For instance, the network entity may be, comprise, or be part of a base station of a communication network of any generation (e.g. a gNB, eNodeB, NodeB, BTS or the like) of the 3GPP standard. Accordingly, the communication system may in particular be a cellular communication system. The network entity may also be or serve as a relay station, such as a mobile relay satellite communicating with a fixed terrestrial base station over a feeder link. Both, the base station and the satellite may be considered a network entity according to the present disclosure. Accordingly, the network entity may be implemented in or communicate with a non-terrestrial entity, such as a satellite. In an example of a 5G network, the non-terrestrial network entity (such as a satellite) may also comprise a gNB-DU, while the gNB-CU is implemented in a terrestrial base station. Generally, the network entity may be or comprise a hardware or software component implementing a certain functionality. In an example, the network entity may be an entity as defined by 3GPP 5G or NR standard (also referred to as gNB). Accordingly, while the network entity may be understood to be implemented in or be a single device or module, the network entity may also be implemented across or comprise multiple devices or modules. As such, the network entity may in particular be implemented in a satellite or be a stationary device utilizing a satellite for communication with a UE. Multiple network entities of the exemplary aspect may in particular establish a communication system or network, which may in particular be a NR or 5G system (5GS) or part thereof or any other mobile communications system defined by a past or future standard, in particular successors of the present 3GPP standards. The network device of the exemplary aspects may be capable of being in direct and/or indirect communication with the exemplary apparatus of the first aspect.

The means or functionality of any of the disclosed apparatuses or network entities can be implemented in hardware and/or software. They may comprise one or multiple modules or units providing the respective functionality. They may for instance comprise at least one processor for executing computer program code for performing the required functions, at least one memory storing the program code, or both. Alternatively, they could comprise for instance circuitry that is designed to implement the required functions, for instance implemented in a chipset or a chip, like an integrated circuit. In general, the means may comprise for instance one or more processing means or processors.

Thus, according to the respective exemplary aspects of the present disclosure, there is in each case also disclosed a respective apparatus or network entity comprising at least one processor and at least one memory including computer program code, the at least one memory and the computer program code configured to, with the at least one processor, cause an apparatus at least to perform a method according to the respective aspect of the present disclosure.

Any of the above-disclosed exemplary aspects may, however, in general be performed by an apparatus, which may be a module or a component for a device, for example a chip. The disclosed apparatus may comprise the disclosed components, for instance means, processor, memory, or may further comprise one or more additional components.

According to the exemplary aspects of the present disclosure, there is in each case also disclosed a computer program, the computer program when executed by a processor of an apparatus causing said apparatus to perform a method according to the respective aspect.

The computer program may in each case be stored on computer-readable storage medium, in particular a tangible and/or non-transitory medium. The computer readable storage medium could for example be a disk or a memory or the like. The computer program could be stored in the computer readable storage medium in the form of instructions encoding the computer-readable storage medium. The computer readable storage medium may be intended for taking part in the operation of a device, like an internal or external memory, for instance a Read-Only Memory (ROM) or hard disk of a computer, or be intended for distribution of the program, like an optical disc.

That the apparatus is configured for communication with a non-terrestrial network is understood to mean that the apparatus may communicate with a network entity of a spaceborne or airborne network, such as satellites, medium earth orbit (MEO) satellites, low earth orbit (LEO) satellites, airborne platforms, aircrafts, airships, unmanned aerial vehicles (UAVs) or high altitude plat forms (HAPs). However, the non-terrestrial network may also comprise terrestrial components (such as terrestrial base stations) and the apparatus may also be configured to communicate directly or indirectly with such terrestrial components. Thus, a non-terrestrial network is in particular understood to be an at least partially non-terrestrial network, i.e. a network which has at least a non-terrestrial component (such as a spaceborne or airborne network entity, e.g. serving as a base station or relay for a base station).

The network entity may transmit, to the apparatus, a handover configuration regarding a handover to be performed by the apparatus from a source cell to a target cell of the network. Accordingly, the apparatus may receive from the network, a handover configuration regarding a handover to be performed by the apparatus from a source cell to a target cell of the network. A handover may also generally be referred to as HO without any limiting intend. A configuration regarding a handover to be performed may for instance be or comprise a handover command. A handover configuration may for instance provide information on the source cell and/or target cell. A handover command may for instance instruct the apparatus to perform a handover. The handover configuration may inter alia indicate whether the handover shall be or is allowed to be a RACH-less handover, e.g. via a ra-Skip field. The information regarding a handover may for instance be a higher level message such as an RRC signaling. In an example, the handover may be a conditional handover, CHO, or a group-based handover. The handover is in particular a non-terrestrial handover, such as a handover within a satellite (e.g. between two cells of a satellite) or between two satellites), i.e. the apparatus is connected to the network via a non-terrestrial entity before and after the handover.

The apparatus may receive, from the network, assistance information, such as satellite assistance information, for the apparatus to connect to the target cell. For instance, the assistance information may be comprised by the handover configuration. For instance, in case of satellites, the assistance information may comprise ephemeris information of the satellite of the source cell and/or the target cell.

The apparatus may determine, based on the assistance information, a type of the handover. Alternatively, the apparatus may receive, from the network, an indication of a type of the handover. A handover type may also be understood to refer to a handover scenario. In particular a type of a handover may be defined by whether or not the handover comprises a change of a network entity, such as one or more of a satellite, a relay station, a gateway, gNB, a gNB-DU or gNB-DU. For instance, a handover type may be defined by whether or not the handover comprises a change of a satellite on the one hand and a change of the gNB or gateway on the other hand. For instance, at least two, three or four different handover types may be defined which can be identified by the apparatus. The handover type does not need to be explicitly signaled in the assistance information. Rather, as will be explained in more detail below, the apparatus is configured to derive the handover type based on other information provided in the assistance information anyways (such as ephemeris information for the satellite of the target cell).

The apparatus may then determine, based on the determined handover type, a threshold for a timing advance parameter. Timing advance may generally also be referred to TA without any limiting intend. For instance, for some or each handover type, there may be a different threshold or threshold value. For instance, as will be explained in more detail below, a respective threshold to be used for a respective handover type may be defined by the specification or may be signaled by the network (e.g. as part of the handover configuration). As will be explained in more detail below, the timing advance parameter may in particular be the N_{TA} parameter. The timing advance parameter may be or may have been signaled to the apparatus by the network.

For this, the network entity may transmit, to the apparatus, threshold information indicating one or more thresholds for a timing advance parameter, said one or more thresholds being associated with respective handover types. Thus, the apparatus can determine or select the appropriate threshold for the determined or indicated type of handover to be performed. While there may be a different threshold for each type of handover, certain handovers may also have the same threshold.

The apparatus may determine, based on the threshold and a value of the timing advance parameter, whether to perform a RACH-less handover towards the target cell. For instance, the threshold may define a condition which needs to be satisfied or fulfilled by the value of the timing advance parameter. For instance, the threshold may be indicative of whether the Timing Advance compensation of the apparatus is accurate enough (e.g. the timing advance parameter is small or short enough) in order to bypass a RACH procedure upon a handover. For instance, depending on whether a value of the timing advance parameter is below or above the threshold, it may be determined whether a RACH-less handover can be performed. If it is determined that no RACH-less handover can be performed to the target cell, the handover process may be modified and one or more fallback options may be available instead of the RACH-less handover to the target cell, as will be explained in more detail further below.

The apparatus may then (depending on said determining whether to perform a RACH-less handover towards the target cell) perform and/or modifying the handover, accordingly. For instance, the apparatus may perform the handover, may not perform the handover or may perform a modified handover, as will be explained in more detail below.

In an example, said determining whether to perform a RACH-less handover towards the target cell comprises comparing the value of the (e.g. present/current or average) timing advance parameter with the determined threshold. For instance, in case the timing advance parameter does comply with (e.g. is smaller or equal than) the determined threshold, the apparatus may decide to perform a RACH-less handover. For instance, in case the timing advance parameter does not comply with (e.g. is larger than) the determined threshold, the apparatus may decide or may be expected to not perform a RACH-less handover.

In an example, the value of the timing advance parameter is one of a current value or average value of the timing advance parameter. A current or present value of the timing advance parameter may be the value of the parameter at the time the handover is executed or triggered to be executed. Alternatively, an average value of the timing advance parameter may be used. For instance, an average value in a given or predetermined time window before or until the handover execution may be used for the comparison with the threshold. Alternatively, an average of the last x values of the timing advance parameter may be used for the comparison with the threshold (with x being e.g. a predefined number).

In an example, the timing advance parameter may be a timing advance parameter or component received from the network. For instance, the timing advance parameter is the timing advance component N_{TA}. The timing advance may be determined based on the timing advance component N_{TA}, for instance according to (N_{TA}+N_{TA-offset}+N_{TA,adj}^{common}+N_{TA,adj}^{UE})×T_{c}, wherein the UE specific Timing Advance parameter N_{TA,adj}^{UE} and the common timing advance parameter N_{TA,adj}^{common} are autonomously maintained by the apparatus in terms of open control loop. The UE specific Timing Advance parameter N_{TA,adj}^{UE} may derived from satellite ephemeris and the (GNSS) location of the apparatus. The common TA N_{TA,adj}^{common} may be calculated using network indicated parameters. Since most of the timing advance is pre-compensated by the apparatus autonomously with parameters N_{TA,adj}^{UE} and N_{TA,adj}^{common}, the N_{TA} component may be used for residual timing advance. Thus the timing advance parameter may in particular be considered to be a residual component of the timing advance. A residual timing advance parameter may in particular be understood as a timing advance parameter or component accounting for one or more of inaccuracies in the GNSS implementation of the apparatus, systematic errors in modelling the feeder link delay (i.e. of the common TA component), and other potential sources of additional delays in the network such as multipath components.

In an example, in case it is determined, based on said comparing, that the value of the timing advance parameter satisfies the determined threshold, the apparatus may perform one or more of the following actions. For instance, the apparatus may set a certain value for the timing advance value e.g. dependent on the situation or based on a received signaling (e.g. as indicated in the received handover configuration, such as a received handover configuration). In an example, the apparatus may set the new value of the timing advance parameter to zero. In another example the apparatus may keep the current value of the timing advance parameter for the new value of the timing advance parameter. In an example, the apparatus may determine a new value (in particular different from zero the current value) for the timing advance parameter to be used. In any case, the apparatus may then perform a RACH-less handover towards the target cell based on a corresponding new (e.g. set, kept or determined) timing advance parameter. In an example, the network may indicate to the apparatus which part or component of the timing advance parameter is to be changed and which part or component is to be kept. For instance, the network may indicate to the apparatus, which part or component of the timing advance parameter is due to network-related offsets and must be kept or changed at the apparatus.

Accordingly, in an example, the apparatus may receive, from the network, an indicator indicating whether a part of the timing advance parameter associated with a network-related offset is to be kept or changed.

In an example in case it is determined, based on said comparing, that the value of the timing advance parameter does not satisfy the threshold, the apparatus may perform one or more of the following actions. The apparatus may perform a handover modification regarding the handover to be performed. In other words, the apparatus may modify the handover configuration, e.g. by modifying a parameter of the handover configuration, the target cell of the handover and/or the timing of the HO, to name just a few examples. In an example, the apparatus may perform a RACH-based handover towards the target cell. Thus, the apparatus may be prevented from a RACH-less handover and instead fallback to a non-RACH-less, i.e. RACH-based, handover. Such a RACH-based handover may be contention based or contention free. In an example, the apparatus may select another target cell. In case multiple potential target cells have been configured (e.g. a candidate list of potential target cells), the apparatus may be able to select a different target cell in order to (potentially) perform a RACH-less handover. For instance, the network may indicate an alternative target cell (e.g. in the handover configuration for the case that the timing advance parameter does not comply with the threshold). In an example, the apparatus may refrain from performing the handover. A new handover may then be performed in case a handover condition is met. In an example, the apparatus may indicate, to the source cell, that a RACH-less handover is not possible. The network may then determine and signal to the apparatus, how to proceed (e.g. the network may suggest or instruct any of the above described options). The apparatus may only be configured with one of these options or may be configured to select from multiple of the above options.

In an example, the type of the handover to be performed is selected from different handover types. For instance, one or more of the following types may be defined. In an example, one handover type may be an intra-satellite handover with the same feeder link (e.g. with the same gateway or gNB). In an example, one handover type may be an intra-satellite handover with different feeder links (e.g. with a gateway or gNB switch). In an example, one handover type may be an inter-satellite handover with different feeder links. In an example, one handover type may be an inter-satellite handover with the same feeder link. However, it is also possible that a different number than four handover types (e.g. less or more) are defined. In the present disclosure, the above handover types are also referred to as handover types (1)-(4), i.e. (1) intra-satellite handover with the same feeder link, (2) intra-satellite handover with different feeder links (3) inter-satellite handover with gateway/gNB switch (4) inter-satellite handover with the same feeder link.

In an example, the determining of a type of the handover may be based on a determining of whether ephemeris information regarding the source cell is sufficiently similar (e.g. identical or only deviating below a certain threshold) to respective ephemeris information regarding the target cell. For instance, in case the ephemeris of the source cell and target cell are indicating a similar or same position (e.g. the same or similar (e.g. slightly shifted) x, y, z, coordinates at a certain time), it can be assumed that the source cell and the target cell are provided by the same satellite and it may be concluded that the handover is an intra-satellite HO, e.g. above case (1) or (2). Otherwise an inter-satellite handover may be assumed.

Additionally or alternatively, the determining of a type of the handover may be based on a determining of whether common delay information regarding the source cell is sufficiently similar (e.g. identical or only deviating below a certain threshold) to respective common delay information regarding the target cell. For instance, common delay information may be one or more common timing advance parameters. For instance, the apparatus may determine whether one or more common timing advance parameters regarding the source cell are sufficiently similar (e.g. identical or only deviating below a certain threshold) to one or more respective common timing advance parameters regarding the target cell. A common timing advance parameter may be N_{TA,adj}^{common} or the parameters describing N_{TA,adj}^{common}. For instance, if the parameters describing the common TA contain the same or similar descriptors for the polynomial for the common TA parameters for the source and target cell, it is assumed that the same feeder link is used (from geometry it can be found that if different feeder links are used, the time-wise description of the expected common TA would change). Hence, for such a case the handover would be considered a handover with the same feeder link, e.g. above case (1) or (4)). In a similar manner, if (sufficiently) different common TA descriptors are used for the source and target cell, the apparatus would consider the handover to be a handover with different feeder links, e.g. above case (2) or (3).

In an example, the threshold has a different value for at least some handover types. For instance, one or more of the different threshold values may at least in part be predefined (e.g. prescribed by a technical specification). For instance, one or more of the different threshold values may be defined in relation to a cyclic prefix, CP, used e.g. for PUSCH. For instance, the threshold may be defined as a percentage of the Cyclic Prefix. For instance, one or more of the different threshold values may be individually configured by the network. For instance, the threshold may account for the amount of the timing advance parameter that is related to network related network offsets. In an example, the threshold might be dependent on a respective offset value for the timing advance parameter (e.g. N_{TA}). This may in particular be the case, when a part of the timing advance parameter is solely or mostly due to network specific delays, i.e. delays on the gateway-gNB transmission. Accordingly, in that case the apparatus may keep the value for the timing advance parameter also upon a handover to a cell utilizing the same feeder link. For instance, considering the case of intra-satellite, intra-feeder link handover, the threshold might be defined to be “infinite”, whereas for “inter-satellite” handover, other limits might apply (for example a certain percentage (e.g. a value between 30 and 50% (e.g. 40%) of the cyclic prefix).

In an example, the assistance information may be or comprise satellite assistance information. Satellite assistance information may in particular comprise information about the satellite of the source cell and/or target cell. For instance, satellite assistance information may comprise ephemeris information on a respective satellite. In an example, the assistance information may be or comprise common delay information. A common delay may be understood as the delay caused by the network side (i.e. non-UE-specific delay). For instance, the assistance information may be received from the network. For instance, the assistance information may originate from the target cell. For instance, the assistance information may originate from the source cell.

In an example, the apparatus may receive, from the network, an indicator indicating whether the apparatus is expected to perform said determining, based on the threshold and the value of the timing advance parameter, whether to perform a RACH-less handover towards the target cell. Thus, the indicator may indicate whether or not the apparatus is allowed to perform a RACH-less handover regardless of said determining whether to perform a RACH-less handover towards the target cell. For instance, a signaling flag may be used by the network to indicate whether the UE should be prevented to perform handover when the timing advance compensation is not accurate enough to bypass the RACH procedure.

It is to be understood that the presentation of the embodiments disclosed herein is merely by way of examples and non-limiting.

Herein, the disclosure of a method step shall also be considered as a disclosure of means for performing the respective method step. Likewise, the disclosure of means for performing a method step shall also be considered as a disclosure of the method step itself.

Other features of the present disclosure will become apparent from the following detailed description considered in conjunction with the accompanying drawings. It is to be understood, however, that the drawings are designed solely for purposes of illustration and not as a definition of the limits of the present disclosure, for which reference should be made to the appended claims. It should be further understood that the drawings are not drawn to scale and that they are merely intended to conceptually illustrate the structures and procedures described herein.

### BRIEF DESCRIPTION OF THE FIGURES

FIG. 1 shows a schematic diagram illustrating an example radio environment in which exemplary embodiments of the present disclosure may be performed;

FIG. 2 shows a further schematic diagram illustrating an example radio environment in which exemplary embodiments of the present disclosure may be performed;

FIG. 3 shows a flow chart of an example embodiment of the present disclosure;

FIG. 4 shows a further flow chart of an example embodiment of the present disclosure;

FIG. 5 shows a further flow chart of an example embodiment of the present disclosure;

FIG. 6 shows a schematic diagram illustrating a block diagram of an exemplary embodiment of an apparatus according to the present disclosure;

FIG. 7 shows a block diagram of an exemplary embodiment of a network entity; and

FIG. 8 shows a schematic illustration of examples of tangible and non-transitory computer-readable storage media.

### DETAILED DESCRIPTION OF THE FIGURES

The following description serves to deepen the understanding of the present disclosure and shall be understood to complement and be read together with the description of example embodiments of the present disclosure as provided in the above SUMMARY section of this specification.

In the following an, an example communication system, in which the present disclosure may be applied, is described. While the specific radio system in the examples below is a 5G system, this is only to be considered a non-limiting example.

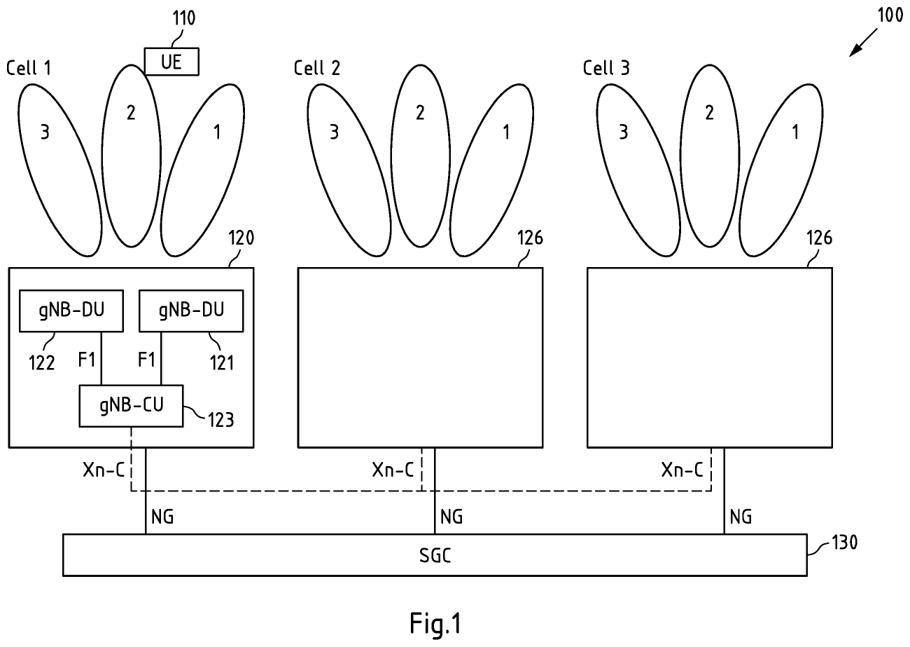

FIG. 1 shows a 5G communication network 100, which introduces the New Radio technology and also an architecture for which the different sublayers of the RAN may be split into two logical entities in a communication network control element (like a BS or gNB), which are referred to as distributed unit (DU) and central unit (CU). For example, the CU is a logical node that controls the operation of one or more DUs over a front-haul interface (referred to as F1 interface). The DU is a logical node including a subset of the gNB functions, depending on the functional split option.

As shown in FIG. 1, a first user equipment (UE) 110, as an example of a first terminal device of the exemplary aspects of the present disclosure, is connected to a cell 1 of a network entity or base station, a gNB 120 via a communication beam of the cell 1. In the example shown in FIG. 1, the gNB 120 is provided with a CU 123 and two DUs 121 and 122 being connected to the CU 123 by a F1 interface. Furthermore, as shown in the example of FIG. 1, there is a plurality of further cells to which the first UE 110 can connect. Naturally, in each cell, a plurality of UEs may be present and connected to the respective cell. Similarly to cell 1, cells 2 and 3 are controlled by gNB 125 and 126, respectively, and each provides a plurality of beams 1 to 3, which may be used for beam diversity or beam hopping. As shown in FIG. 1, each base station or gNB of the cells is connected to a core network 130, such as a 5GC, via respective interfaces, indicated as NG interfaces. Furthermore, each gNB of the cells is connected with each other by means of a specific interface, which is referred to e.g. as an Xn-C interface. Any of these network entities, such as the gNB, gNB-DU, gNB-CU and/or 5GC, may individually or together be an example of a base station or a part thereof according to the present disclosure.

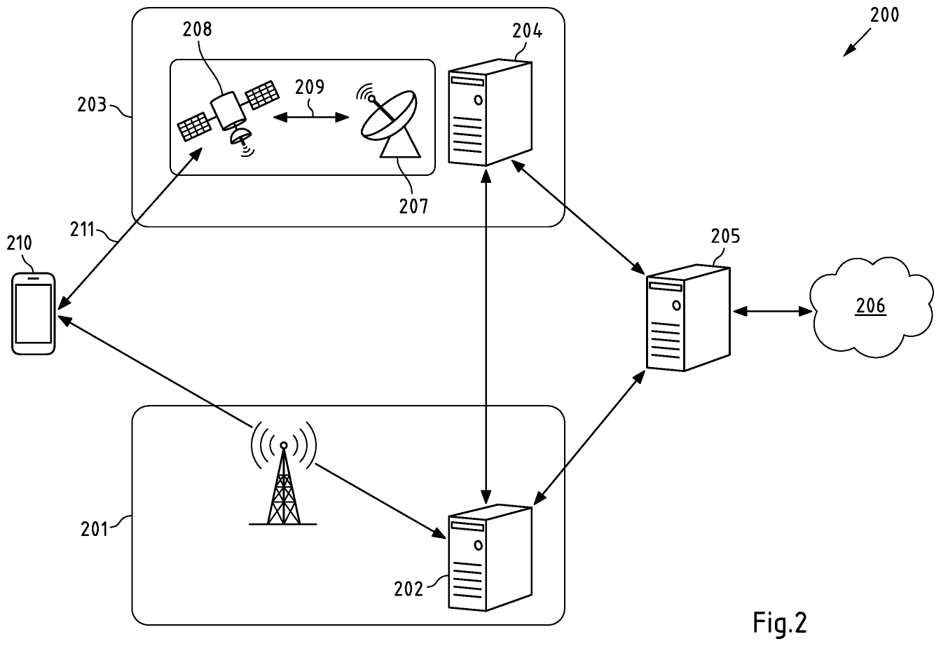

The communication between the UE and the respective network entities or base stations may at least partially be realized via a non-terrestrial network 200, as exemplarily shown in FIG. 2. The UE 210 may communicate via a Uu interface not only with a terrestrial NG-RAN 201 with gNB 202, but also with an NTN-based NG-RAN 203 with gNB 204. In each case, the respective gNB communicates with a 5GC 205 and data network 206. The gNB 204 communicates with the UE 210 via an NTN gateway 207 and satellite 208 and functioning as a relay. NTN gateway 207 and satellite 208 are connected via a feeder link 209, which is common to all UEs connected to the satellite vie service link 211 and which may be UE specific. While in the example shown, the gNB is completely terrestrial, it is also possible that the gNB functionality is completely or at least partially implemented in the satellite 208. For instance, satellite 208 may comprise a gNB-DU, while the terrestrial gNB 204 may then be or comprise a gNB-CU. In each of the cases, the UE 210 may, however, also be configured to only communicate with the non-terrestrial part 203 of the network.

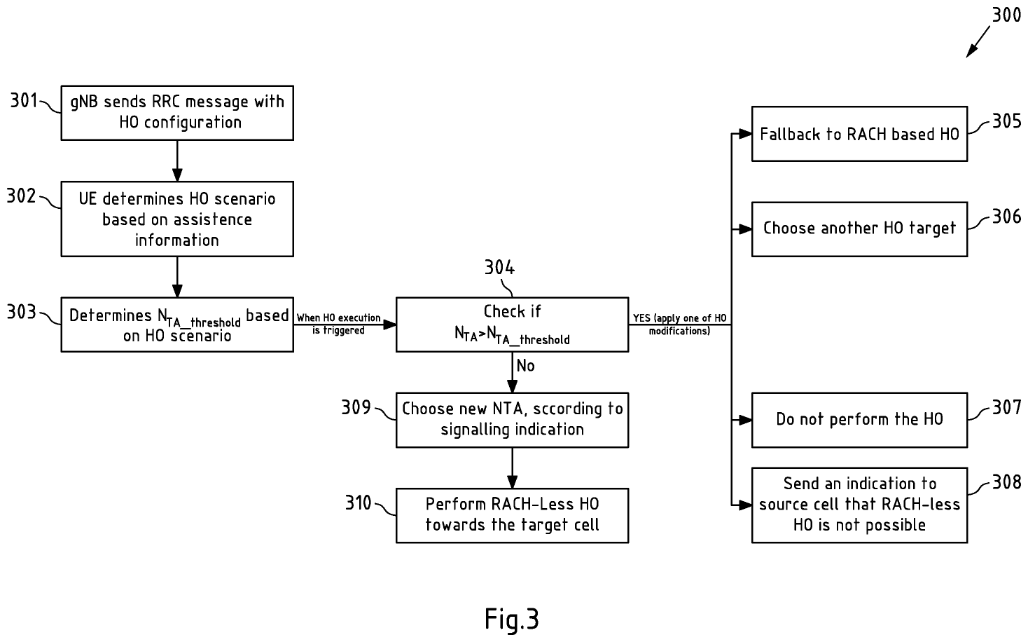

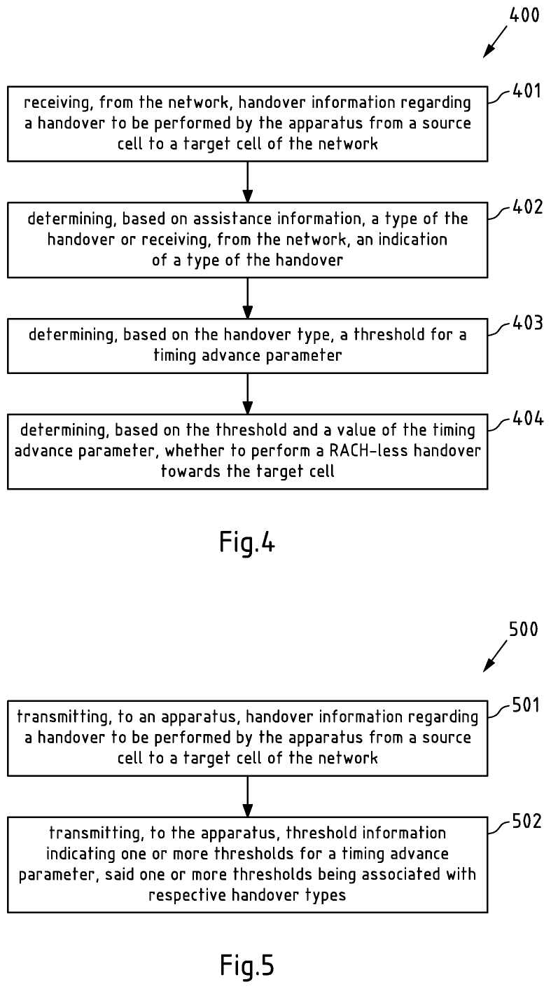

As will now be described in more detail with respect to FIGS. 3 and 4, showing respective exemplary flow charts, the disclosure now provides methods to be used during RACH-less HO in NTN (such as the one described above) regarding the timing advance residual component. In the following the timing advance parameter N_{TA} for determining the timing advance (N_{TA}+N_{TA-offset}+N_{TA,adj}^{common}+N_{TA,adj}^{UE})×T_{c} is understood to be the timing advance residual component.

A long residual component might be related to GNSS inaccuracy, or long reflective paths, indoor UEs or UEs using other solutions for assisted transmissions (e.g. repeaters and TRPs), or it might have been introduced by the network to account for additional delays needed (e.g. delays on the Gateway-gNB transmission). These factors might cause different effects for different HO types.

Considering the exemplary situation of a UE performing an intra-satellite and intra-feeder link HO, the UE might expect that the position of the transmission and reception points, TRPs, and the respective delays are actually not changing after the HO. In this case, it is likely that the parameter N_{TA} does not need to change after the HO. If the N_{TA} component was incremented due to the network related offsets (such as the described GW-gNB path), the NTA might be also relevantly kept when the feeder links is maintained after the HO procedure. Therefore the described embodiment may account for these factors. Such determination of whether or not the UE is allowed to maintain N_{TA} for such cases may be part of the configuration parameters for the HO procedure (e.g., through a configured threshold or through indication which HO cases may be considered “valid” for this situation).

Turning now to FIGS. 3 and 4, the UE is first being configured with a RACH-Less HO command, which may be a conventional HO, a group based HO or a Conditional HO for instance (action 301, 401). The handover configuration or command comprises satellite assistance data of the respective satellite for the source and/or target cell.

While the network may signal the type of handover (e.g. with or without satellite change, with or without feeder link change) to the UE, the UE may also determine the type of HO being performed based on such the satellite assistance information (action 302, 402). For instance, the UE may assume an intra-satellite HO if the ephemeris information is the same or very similar (for example a shifted version in time due to satellite movements) to the one for the current source cell, corresponding to handover scenarios types (1) or (2) as defined above. Otherwise (i.e. of the ephemeris information is not the same or sufficiently similar), it is determined to be a HO type (3) or (4). For instance, if the satellite ephemeris of the two cells (source and target) is indicating the same geographical position (x,y,z coordinates at time “t”), it is assumed that it is an intra-satellite handover, type (1) or (2), while if position is not the same, it is assumed an inter-satellite handover.

Likewise, the UE may decide based on the similarity between the common delay information for the target and source cell whether the handover comprises a switch of the gNB or gateway. For instance, if the parameters describing the “common TA” contain the same descriptors for the polynomial for the expected common TA parameters, it is assumed that the same feeder link is used (from geometry it can be found that if different feeder links are used, the time-wise description of the expected common TA will also change)—and hence the HO would be considered a Handover with the same gNB/gateway, see above cases (1) or (4) handover. In a similar manner, if different Common TA descriptors are used for the two cells, the UE would consider it to be a HO with different gnBs/gateways, see above cases (2) or (3).

The UE then determines a threshold N_{TA_threshold} based on the determined HO scenario (action 303, 403). The threshold values might have different values for different HO types. The threshold might be defined (hard-coded) in the specification, for instance as a percentage of the Cyclic Prefix, CP, for PUSCH. The threshold may also be or individually configured by the network in each case, e.g. to account for the amount of N_{TA} that is related to network related offsets. For instance, the threshold might be dependent on offset values for N_{TA}, depending on the HO type. For instance, when a part of N_{TA} it is mostly due to network specific delays, i.e. delays on the gateway-gNB transmission, the N_{TA} offset might be kept after the HO. For example: in the case of a intra-satellite, intra-feeder link HO, the threshold might be set to “infinite”, whereas for “inter-satellite” HO, other limits might apply (such as 40% of the CP).

For a conditional handover (CHO), the handover execution might happen a long time after the HO configuration was received at the UE and, consequently, the residual timing advance component might also change in this interval. However, for conventional HO, the HO might be executed upon reception of HO command). For a group-based HO, it may also be possible that the execution is upon the reception of the HO information, or at a time scheduled for the UEs in the group while the actual configuration preparation, including RACH part, happened much earlier. In the scope of such cases, a respective UE would have to check individually, as will be described below in detail, whether the RACH-less condition is satisfied at the time of the handover.

Now, when the HO is to be executed, the UE determines whether to perform a RACH-less HO by comparing the value of N_{TA} with the threshold value (action 304, 404). For the value of N_{TA} the current value for N_{TA} or the average value of N_{TA} in a given window of time before the HO execution may be considered.

If the value of N_{TA} does not satisfy the threshold (e.g. the absolute value larger than the threshold), the UE is required to modify the HO configuration and may in particular fall back to a non-RACH-less HO scenario. Examples of such modification may one or more of the following. The UE may fall back to the HO execution with RACH procedure (action 305). If no RACH resources are pre-assigned, the UE may also execute a Contention-Based RACH procedure (CBRA). For CHO, the UE may choose or may be requested to choose another target cell if multiple CHO candidates have been configured (action 306). For instance, the different target cell IDs may be indicated by network in the same handover configuration or command as an additional target cell to handover to only in case the value of N_{TA} is above the threshold. The UE may be prevented to finalize the HO execution (action 307). However, this approach may lead to a radio link failure (RLF), so the UE may report this issue to the source cell, if the link is still available (action 308).

If the condition is fulfilled (e.g. the absolute value smaller than or equal to the threshold), the UE performs the RACH-Less HO (action 310). The UE may determine or set the value of N_{TA} to be used for the RACH-less HO (action 309). For this, a network signaling may be used (e.g. in the HO configuration) to indicate the value of N_{TA} to be used for the RACH-less HO, e.g. whether the UE shall keep the value of N_{TA}, make equal to zero or determine a new value. For this, a network signaling might be used to indicated to the UE what part of N_{TA} is due to network-related offsets and must be kept or changed at the UE side.

As exemplarily illustrated in the flow chart 500 of FIG. 5, the network may transmit, to an apparatus (such as the apparatus described above, handover information (i.e. a handover configuration) regarding a handover to be performed by the apparatus from a source cell to a target cell of the network (action 501). As part of the handover configuration or separate therefrom, the network entity may transmit, to the apparatus, threshold information indicating one or more thresholds for a timing advance parameter, wherein said one or more thresholds are associated with respective handover types (action 502). This may enable the apparatus to determine or select the appropriate threshold for the determined or indicated type of handover to be performed. While there may be a different threshold for each type of handover, certain handovers may also have the same threshold.

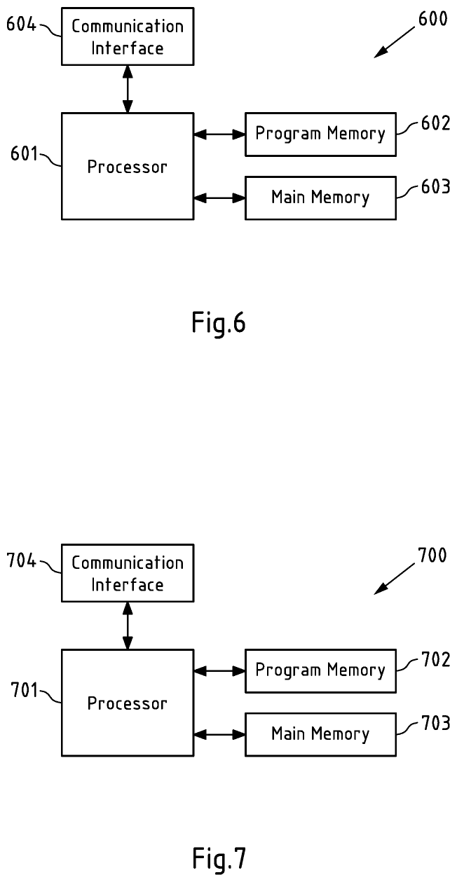

Turning now to FIG. 6, there is shown a block diagram of an exemplary embodiment of an apparatus or UE 600 according to the present disclosure. For example, UE 600 may be one of a smartphone, a tablet computer, a notebook computer, a smart watch, a smart band, an LPWAN device, an IoT device, an eMTC device or a vehicle or a part thereof.

UE 600 comprises a processor 601. Processor 601 may represent a single processor or two or more processors, which are for instance at least partially coupled, for instance via a bus. Processor 601 executes a program code stored in program memory 602 (for instance program code causing mobile device 600 in connection with a network entity or base station) to perform one or more of the embodiments of a method according to the present disclosure or parts thereof, when executed on processor 601, and interfaces with a main memory 603. Program memory 602 may also contain an operating system for processor 601. Some or all of memories 602 and 603 may also be included into processor 601.

One of or both of a main memory and a program memory of a processor (e.g. program memory 602 and main memory 603) could be fixedly connected to the processor (e.g. processor 801) or at least partially removable from the processor, for instance in the form of a memory card or stick.

A program memory (e.g. program memory 602) may for instance be a non-volatile memory. It may for instance be a FLASH memory (or a part thereof), any of a ROM, PROM, EPROM, MRAM or a FeRAM (or a part thereof) or a hard disc (or a part thereof), to name but a few examples. For example, a program memory may for instance comprise a first memory section that is fixedly installed, and a second memory section that is removable from, for instance in the form of a removable SD memory card.

A main memory (e.g. main memory 603) may for instance be a volatile memory. It may for instance be a DRAM memory, to give non-limiting example. It may for instance be used as a working memory for processor 601 when executing an operating system, an application, a program, and/or the like.

Processor 601 further controls a communication interface 604 (e.g. radio interface) configured to receive and/or transmit data and/or information. For instance, communication interface 604 may be configured to transmit and/or receive radio signals from a radio node, such as a base station, in particular as described herein. Communication interface 604 may in particular be configured for communication with a NTN and with a GNSS. However, it may not be possible to operate communication interface for communication with the NTN and with the GNSS at the same time. It is to be understood that any computer program code based processing required for receiving and/or evaluating radio signals may be stored in an own memory of communication interface 604 and executed by an own processor of communication interface 604 and/or it may be stored for example in memory 603 and executed for example by processor 601.

Additionally, the communication interface 604 may further comprise a BLE and/or Bluetooth radio interface including a BLE transmitter, receiver or transceiver. For example, radio interface 604 may additionally or alternatively comprise a WLAN radio interface including at least a WLAN transmitter, receiver or transceiver.

The components 602 to 604 of terminal device 600 may for instance be connected with processor 601 by means of one or more serial and/or parallel busses.

It is to be understood that terminal device 600 may comprise various other components. For example, terminal device 600 may optionally comprise a user interface (e.g. a touch-sensitive display, a keyboard, a touchpad, a display, etc.).

FIG. 7 is a block diagram of an exemplary embodiment of a network entity 700, such as a base station (in particular a non-terrestrial network entity or gNB). For instance, network entity 700 may be configured for scheduling and/or transmitting signals to the UE, as described above.

Network entity 700 comprises a processor 701. Processor 701 may represent a single processor or two or more processors, which are for instance at least partially coupled, for instance via a bus. Processor 701 executes a program code stored in program memory 702 (for instance program code causing network entity 700 to perform alone or together with the apparatus 600 embodiments according to the present disclosure or parts thereof), and interfaces with a main memory 703.

Program memory 702 may also comprise an operating system for processor 701. Some or all of memories 702 and 703 may also be included into processor 701.

Moreover, processor 901 controls a communication interface 704 which is for example configured to communicate according to a cellular communication system like a 2G/3G/4G/5G cellular communication system. Communication interface 704 of apparatus 700 may be realized by radio heads for instance and may be provided for communication between network entity and the apparatus, as described above.

The components 702 to 704 of network entity 700 may for instance be connected with processor 701 by means of one or more serial and/or parallel busses.

It is to be understood that apparatuses 600, 700 may comprise various other components.

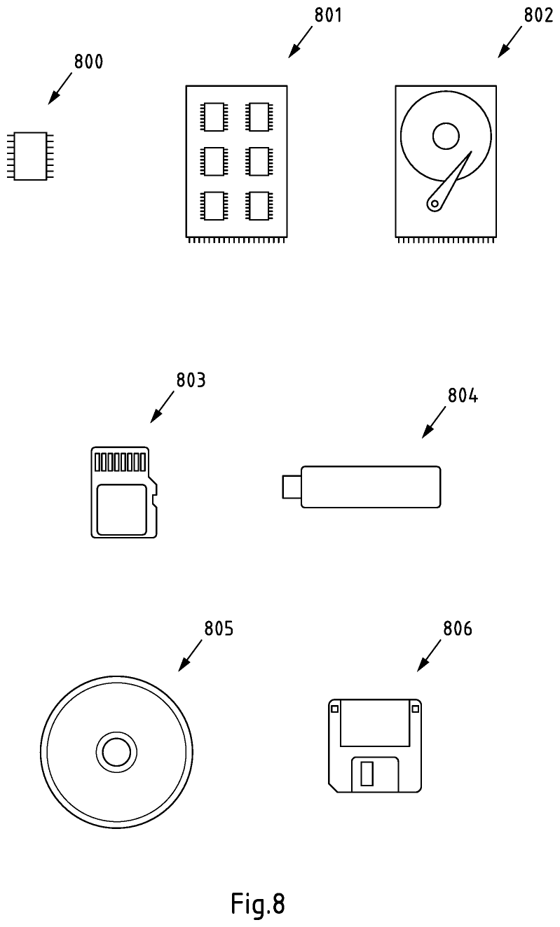

FIG. 8 is a schematic illustration of examples of tangible and non-transitory computer-readable storage media according to the present disclosure that may for instance be used to implement memory 602 of FIG. 6 or memory 702 of FIG. 7. To this end, FIG. 8 displays a flash memory 800, which may for instance be soldered or bonded to a printed circuit board, a solid-state drive 801 comprising a plurality of memory chips (e.g. Flash memory chips), a magnetic hard drive 802, a Secure Digital (SD) card 803, a Universal Serial Bus (USB) memory stick 804, an optical storage medium 805 (such as for instance a CD-ROM or DVD) and a magnetic storage medium 806.

The following embodiments are also disclosed:
1. An apparatus for communication with a non-terrestrial network, NTN, the apparatus comprising means configured for:
   receiving, from the network, a handover configuration regarding a handover to be performed by the apparatus from a source cell to a target cell of the network;
   receiving, from the network, assistance information for the apparatus to connect to said target cell;
   determining, based on the assistance information, a type of the handover or receiving, from the network, an indication of a type of the handover;
   determining, based on the handover type, a threshold for a timing advance parameter;
   determining, based on the threshold and a value of the timing advance parameter, whether to perform a RACH-less handover towards the target cell.
2. The apparatus of embodiment 1, wherein said value of the timing advance parameter is one of a current value or average value of the timing advance parameter.
3. The apparatus of embodiment 1 or 2, wherein the timing advance parameter is a timing advance component received from the network.
4. The apparatus of any of embodiments 1-3, wherein said determining whether to perform a RACH-less handover towards the target cell comprises comparing the value of the timing advance parameter with the threshold.
5. The apparatus of embodiment 4, wherein the means are further configured for, in case it is determined, based on said comparing, that the value of the timing advance parameter satisfies the threshold, one or more of the following:
   determining a new value for the timing advance parameter; and/or
   setting the new value of the timing advance parameter to zero;
   keeping the current value of the timing advance parameter for the new value of the timing advance parameter;
   performing a RACH-less handover towards the target cell based on a new value of the timing advance parameter.
6. The apparatus of embodiment 4 or 5, wherein the means are further configured for, in case it is determined, based on said comparing, that the value of the timing advance parameter does not satisfy the threshold, one or more of:
   performing a modification regarding the handover to be performed;
   performing a RACH-based handover towards the target cell;
   selecting another target cell;
   refraining from performing the handover; and/or
   indicating, to the source cell, that a RACH-less handover is not possible.
7. The apparatus of any of the embodiments 1-6, wherein the type of the handover to be performed is selected from one or more of the following:
   intra-satellite handover with the same feeder link;
   intra-satellite handover with different feeder links;
   inter-satellite handover with different feeder links; and/or
   inter-satellite handover with the same feeder link.
8. The apparatus of any of embodiments 1-7, wherein said determining of a type of the handover is based on one or more of
   determining whether ephemeris information regarding the source cell is sufficiently similar to respective ephemeris information regarding the target cell; and/or
   determining whether common delay information regarding the source cell is sufficiently similar to respective common delay information regarding the target cell.
9. The apparatus of any of embodiments 1-8, wherein the threshold has a different value for at least some HO types, wherein one or more of the different threshold values may be one or more of
   at least in part predefined;
   defined in relation to a cyclic prefix;
   individually configured by the network.
10. The apparatus of any of embodiments 1-9, wherein the means are further configured for:
   receiving, from the network, an indicator indicating whether a part of the timing advance parameter associated with a network-related offset is to be kept or changed.
11. The apparatus of any of embodiments 1-10, wherein the assistance information:
   originates from the target cell;
   originates from the source cell;
   is or comprises satellite assistance information; and/or
   is or comprises common delay information.
12. The apparatus of any of embodiments 1-11, wherein the means are further configured for:
   receiving, from the network, an indicator indicating whether the apparatus is expected to perform said determining, based on the threshold and the value of the timing advance parameter, whether to perform a RACH-less handover towards the target cell.
13. A network entity for a non-terrestrial network, NTN, the network entity comprising means configured for:
   transmitting, to an apparatus, handover information regarding a handover to be performed by the apparatus from a source cell to a target cell of the network;
   transmitting, to the apparatus, threshold information indicating one or more thresholds for a timing advance parameter, said one or more thresholds being associated with respective handover types.
14. A method for communication with a non-terrestrial network, NTN, performed by at least one apparatus, the method comprising:
   receiving, from the network, a handover configuration regarding a handover to be performed by the apparatus from a source cell to a target cell of the network;
   receiving, from the network, assistance information for the apparatus to connect to said target cell;
   determining, based on the assistance information, a type of the handover or receiving, from the network, an indication of a type of the handover;
   determining, based on the handover type, a threshold for a timing advance parameter;
   determining, based on the threshold and a value of the timing advance parameter, whether to perform a RACH-less handover towards the target cell.
15. A method, performed by at least one network entity of a non-terrestrial network, NTN, the method comprising:
   transmitting, to an apparatus, a handover configuration regarding a handover to be performed by the apparatus from a source cell to a target cell of the network;
   transmitting, to the apparatus, threshold information indicating one or more thresholds for a timing advance parameter, said one or more thresholds being associated with respective handover types.
16. Computer program code, the computer program code when executed by a processor of an apparatus causing said apparatus to perform a method of embodiment 14 or 15.
17. Computer storage medium comprising computer program code of embodiment 16

Any presented connection in the described embodiments is to be understood in a way that the involved components are operationally coupled. Thus, the connections can be direct or indirect with any number or combination of intervening elements, and there may be merely a functional relationship between the components.

Further, as used in this text, the term ‘circuitry’ refers to any of the following:
(a) hardware-only circuit implementations (such as implementations in only analog and/or digital circuitry)
(b) combinations of circuits and software (and/or firmware), such as: (i) to a combination of processor(s) or (ii) to sections of processor(s)/software (including digital signal processor(s)), software, and memory(ies) that work together to cause an apparatus, such as a mobile phone, to perform various functions) and
(c) to circuits, such as a microprocessor(s) or a section of a microprocessor(s), that require software or firmware for operation, even if the software or firmware is not physically present.

This definition of ‘circuitry’ applies to all uses of this term in this text, including in any claims. As a further example, as used in this text, the term ‘circuitry’ also covers an implementation of merely a processor (or multiple processors) or section of a processor and its (or their) accompanying software and/or firmware. The term ‘circuitry’ also covers, for example, a baseband integrated circuit or applications processor integrated circuit for a mobile phone.

Any of the processors mentioned in this text, in particular but not limited to processors 801 and 901 of FIGS. 8 and 9, could be a processor of any suitable type. Any processor may comprise but is not limited to one or more microprocessors, one or more processor(s) with accompanying digital signal processor(s), one or more processor(s) without accompanying digital signal processor(s), one or more special-purpose computer chips, one or more field-programmable gate arrays (FPGAS), one or more controllers, one or more application-specific integrated circuits (ASICS), or one or more computer(s). The relevant structure/hardware has been programmed in such a way to carry out the described function.

Moreover, any of the actions or steps described or illustrated herein may be implemented using executable instructions in a general-purpose or special-purpose processor and stored on a computer-readable storage medium (e.g., disk, memory, or the like) to be executed by such a processor. References to ‘computer-readable storage medium’ should be understood to encompass specialized circuits such as FPGAs, ASICs, signal processing devices, and other devices.

Moreover, any of the actions described or illustrated herein may be implemented using executable instructions in a general-purpose or special-purpose processor and stored on a computer-readable storage medium (e.g., disk, memory, or the like) to be executed by such a processor. References to ‘computer-readable storage medium’ should be understood to encompass specialized circuits such as FPGAs, ASICs, signal processing devices, and other devices.

The wording “A, or B, or C, or a combination thereof” or “at least one of A, B and C” may be understood to be not exhaustive and to include at least the following: (i) A, or (ii) B, or (iii) C, or (iv) A and B, or (v) A and C, or (vi) B and C, or (vii) A and B and C.

It will be understood that the embodiments disclosed herein are only exemplary, and that any feature presented for a particular exemplary embodiment may be used with any aspect of the present disclosure on its own or in combination with any feature presented for the same or another particular exemplary embodiment and/or in combination with any other feature not mentioned. It will further be understood that any feature presented for an example embodiment in a particular category may also be used in a corresponding manner in an example embodiment of any other category.
CBRA Contention Based Random Access
CFRA Contention Free Random Access
CHO Conditional Handover
CP Cyclic Prefix
GNSS Global Navigation Satellite System
HO Handover
LEO Low Earth Orbit
NR New Radio
NTN Non-terrestrial network
RA Random Access
RACH Random Access Channel
RRC Radio Resource Control
RTT Round Trip Time
SIB System Information Broadcast
TA Timing Advance
UE User Equipment

1. An apparatus for communication with a non-terrestrial network, NTN, the apparatus comprises at least one memory storing the program code, when executed by at least one processor, configures the apparatus to:
receive, from the network, a handover configuration regarding a handover to be performed by the apparatus from a source cell to a target cell of the network;
receive, from the network, assistance information for the apparatus to connect to said target cell;
determine, based on the assistance information, a type of the handover or receiving, from the network, an indication of a type of the handover;
determine, based on the handover type, a threshold for a timing advance parameter; and
determine, based on the threshold and a value of the timing advance parameter, whether to perform a RACH-less handover towards the target cell.

2. The apparatus of claim 1, wherein said value of the timing advance parameter is one of a current value or average value of the timing advance parameter.

3. The apparatus of claim 1, wherein the timing advance parameter is a timing advance component received from the network.

4. The apparatus of claim 1, wherein said determining whether to perform a RACH-less handover towards the target cell comprises comparing the value of the timing advance parameter with the threshold.

5. The apparatus of claim 4, wherein in case it is determined, based on said comparing, that the value of the timing advance parameter satisfies the threshold, the apparatus is configured to one or more of the following:
set the new value of the timing advance parameter to zero;
keep the current value of the timing advance parameter for the new value of the timing advance parameter;
determine a new value for the timing advance parameter; and/or
perform a RACH-less handover towards the target cell based on a new value of the timing advance parameter.

6. The apparatus of claim 4, in case it is determined, based on said comparing, that the value of the timing advance parameter does not satisfy the threshold, the apparatus is configured to one or more of:
perform a modification regarding the handover to be performed;
performing a RACH-based handover towards the target cell;
select another target cell;
refrain from performing the handover; and/or
indicate, to the source cell, that a RACH-less handover is not possible.

7. The apparatus of the claim 1, wherein the type of the handover to be performed is selected from one or more of the following:
intra-satellite handover with the same feeder link;
intra-satellite handover with different feeder links;
inter-satellite handover with different feeder links; and/or
inter-satellite handover with the same feeder link.

8. The apparatus of claim 1, wherein said determining of a type of the handover is based the apparatus is configured to on one or more of:
determine whether ephemeris information regarding the source cell is sufficiently similar to respective ephemeris information regarding the target cell; and/or
determine whether common delay information regarding the source cell is sufficiently similar to respective common delay information regarding the target cell.

9. The apparatus of claim 1, wherein the threshold has a different value for at least some HO types, wherein one or more of the different threshold values being one or more of
at least in part predefined;
defined in relation to a cyclic prefix;
individually configured by the network.

10. The apparatus of claim 1, wherein the apparatus is further configured to:
receive, from the network, an indicator indicating whether a part of the timing advance parameter associated with a network-related offset is to be kept or changed.

11. The apparatus of claim 1, wherein the assistance information:
originates from the target cell;
originates from the source cell;
is or comprises satellite assistance information; and/or
is or comprises common delay information.

12. The apparatus of claim 1, wherein the apparatus is further configured to:
receive, from the network, an indicator indicating whether the apparatus is expected to perform said determining, based on the threshold and the value of the timing advance parameter, whether to perform a RACH-less handover towards the target cell.

13. A network entity for a non-terrestrial network, NTN, the network entity comprises at least one memory storing the program code, when executed by at least one processor, configures the apparatus to:
transmit, to an apparatus, a handover configuration regarding a handover to be performed by the apparatus from a source cell to a target cell of the network;
transmit, to the apparatus, threshold information indicating one or more thresholds for a timing advance parameter, said one or more thresholds being associated with respective handover types.

14. A method for communication with a non-terrestrial network, NTN, performed by at least one apparatus, the method comprising:
receiving, from the network, a handover configuration regarding a handover to be performed by the apparatus from a source cell to a target cell of the network;
receiving, from the network, assistance information for the apparatus to connect to said target cell;
determining, based on the assistance information, a type of the handover or receiving, from the network, an indication of a type of the handover;
determining, based on the handover type, a threshold for a timing advance parameter;
determining, based on the threshold and a value of the timing advance parameter, whether to perform a RACH-less handover towards the target cell.
